(19) United States
(12) Patent Application Publication
(10) Pub. No.: US 2011/0199219 A1
(43) Pub. Date: Aug. 18, 2011

(54) Life spring

(76) Inventor: Lowell M. Smith, Austin, TX (US)

(21) Appl. No.: 12/658,811

(22) Filed: Feb. 16, 2010

(51) Int. Cl. G08B 21/00

(52) U.S. Cl. 340/604

(57) ABSTRACT

Apparatus and methods for indicating whether a vehicle is partially or completely submerged. In one embodiment, an apparatus comprises a circuit and a body. The circuit includes a moisture sensor, indicator, and power adaptor. The moisture sensor generates an output signal responsive to whether it senses moisture. The indicator outputs an indication of whether the moisture sensor senses moisture. The power adaptor is dimensioned to fit in a vehicle power outlet while the moisture sensor and indicator are mounted on the body which can include a surface for accepting an advertising logo. In some embodiments, the apparatus includes a spring-loaded glass breaking device. Moreover, the power adaptor can be mounted on the body or can be the body. The circuit can include a re-chargeable battery and re-charging circuit. Moreover, the indicator can be either visual (for instance, an LED) or audible and can be timed to output the indicator periodically.

### BACKGROUND

Flash floods endanger hundreds of vehicle drivers every year. In some areas these floods arise so quickly that water traps drivers caught in low lying areas in their vehicles. In other circumstances drivers (perhaps believing that water covering a roadway or other surface is shallow enough to safely drive through) attempt to cross a submerged section of the roadway and, to their dismay, find themselves trapped in a submerged vehicle. In still other circumstances, a vehicle may run off of a road and into a body of water whereupon pressure developed by the water on the vehicle's doors makes opening the doors (and hence escaping) difficult or impossible. While driving into water is not advisable for at least these reasons, some drivers (and others) nevertheless find themselves in submerged, or partially submerged, vehicles.

### SUMMARY

The following presents a simplified summary of some aspects of the disclosure to provide a basic understanding of the same. This summary is not an extensive overview of the disclosed subject matter, and is not intended to identify key or critical elements or the scope of the disclosure. Instead, this summary serves as a prelude to the detailed description that is presented herein.

This document discloses apparatus, systems, methods, etc. for sensing whether a vehicle is (partially or completely) submerged and for enabling the driver (and/or passengers) to escape from the vehicle in such circumstances. This document also discloses methods of advertising (and advertising apparatus and systems) in conjunction with the same.

To the accomplishment of the foregoing and related ends, certain illustrative embodiments are disclosed herein in conjunction with the accompanying drawings. These illustrative embodiments indicate various ways in which the disclosed subject matter may be practiced, all of which (and their equivalents) are within the scope of the disclosure. Other advantages and features will become apparent from the disclosure.

### BRIEF DESCRIPTION OF THE DRAWINGS

The detailed description is described with reference to the accompanying figures. In these figures, the use of the same reference numbers in different figures generally indicates the same or similar items. Moreover, reference numbers which share the same left most digit(s) generally appear first in a figure which corresponds to that shared left most digit.

FIG. 1 illustrates a submerged vehicle.

FIG. 2 illustrates an apparatus for sensing whether a vehicle is submerged and for enabling a user to escape from the same.

FIG. 2A illustrates another apparatus for sensing whether a vehicle is submerged and for enabling a user to escape from the same.

FIG. 3 illustrates a cross sectional view of an apparatus for sensing whether a vehicle is submerged and for enabling a user to escape from the same.

FIG. 4 illustrates a block diagram of an apparatus for sensing whether a vehicle is submerged.

FIG. 5 illustrates a block diagram of another apparatus for sensing whether a vehicle is submerged.

FIG. 6 illustrates a schematic diagram of a circuit for sensing whether a vehicle is submerged.

FIG. 7 illustrates a flowchart of a method for advertising and for sensing whether a vehicle is submerged.

FIG. 8 illustrates a schematic diagram of a circuit for sensing whether a vehicle is submerged.

### DETAILED DESCRIPTION

This document discloses apparatus, systems, methods, etc. for sensing whether a vehicle is (partially or completely) submerged and for enabling the driver (and/or passengers) to escape from the vehicle in such circumstances. This document also discloses methods of advertising (and advertising apparatus and systems) in conjunction with the same.

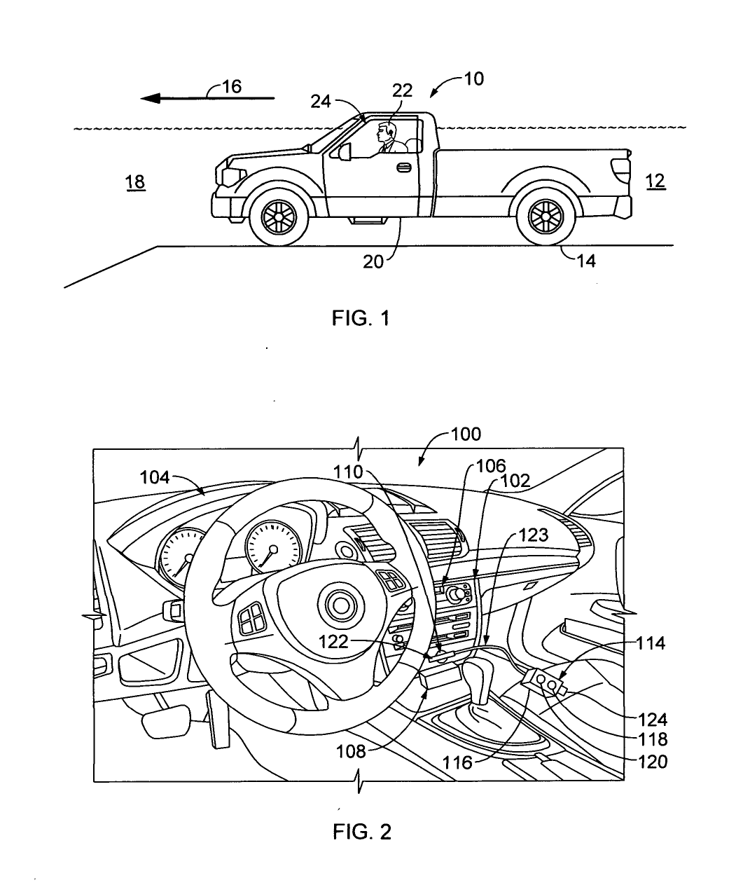

With reference now to the figures, FIG. 1 illustrates a submerged vehicle. More particularly, FIG. 1 illustrates that the vehicle 10 is partially submerged in water 12 that happens to be relatively shallow and that happens to be flowing rapidly across a roadway 14 (as indicated by arrow 16). Moreover, reference 18 indicates a volume of deeper water 18 into which the vehicle 10 might be pushed by the rapidly moving water 12 or into which the vehicle 10 might otherwise move. Indeed, the deeper water 18 might have sufficient depth to completely submerge the vehicle 10. However, the water 12 or 18 need not be of any particular depth and need not be moving with any particular velocity. Indeed, the water 12 could be still or non-flowing such as the water 12 found in a lake, pond, or other relatively stationary body of water. Nonetheless, as the vehicle 10 sinks, the increasing water pressure on the doors 20, hatches, etc. of the vehicle 10 make opening the same difficult.

Regardless of the reason for the vehicle 10 being in the water 12 or 18, the user 22 of the vehicle 10 will typically be anxious due to being in such a position. As a result, some users 22 will act in an ineffective manner (for instance, attempting to force a door open against the water pressure) trying to escape from the submerged vehicle 10. However, even if the vehicle 10 becomes submerged, it remains possible to escape from the vehicle 10 by either waiting for the pressure to equalize and then opening a door to egress the vehicle. However, many users may be uncomfortable waiting for the pressure to equalize and may wish to egress the vehicle more expeditiously. In which case the user 22 can break one of the windows 24 of the vehicle 10 to let the pressure equalize and to egress through the resulting opening. However, vehicle windows 24 typically resist breakage. Thus, it may be desirable to provide a tool for use in escaping from a submerged vehicle 10 which (in some manner) draws attention to such a tool in the hopes that even anxious users 22 will notice the same. Such users 22, it is hoped, will overcome their anxiety well enough to save themselves. Of course, users 22 need not be anxious or reacting ineffectively to benefit from the presence of such a tool in the vehicle 10.

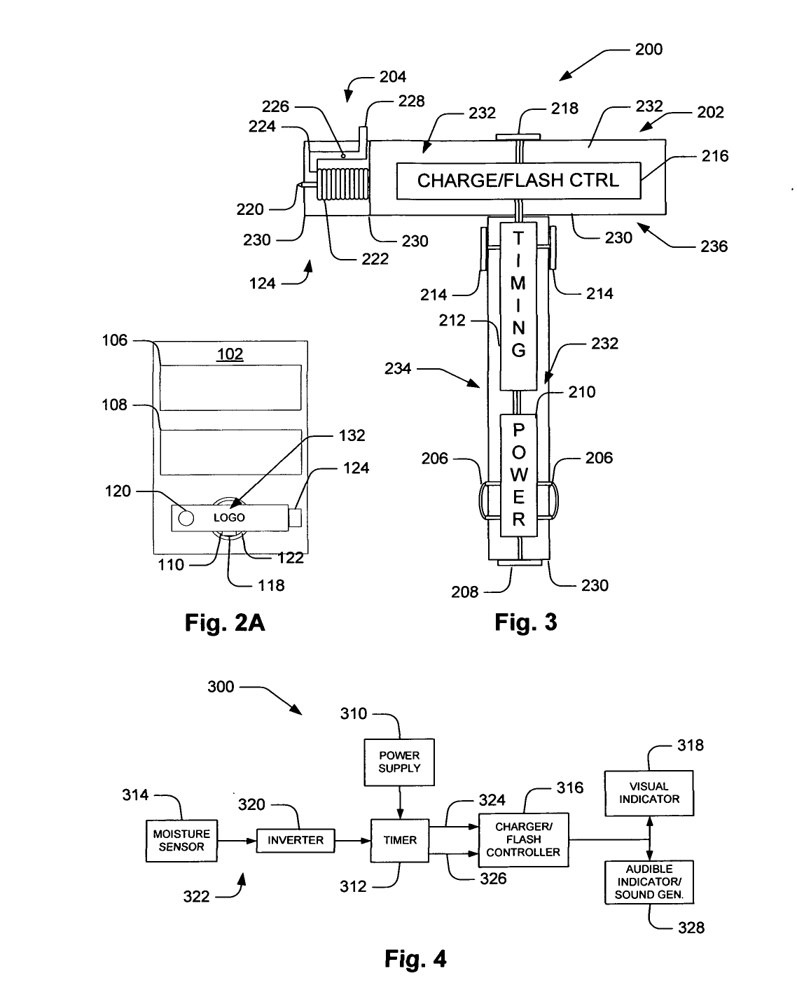

FIG. 2 illustrates an apparatus for sensing whether a vehicle is submerged and for enabling a user to escape from the same. More particularly, FIG. 2 illustrates an apparatus for providing a tool for escaping from a submerged vehicle 10, sensing whether the vehicle 10 is submerged, and (if so) for drawing attention to itself. More particularly, FIG. 2 illustrates a dashboard 100 of the vehicle 10 including a console 102. While the dashboard 100 often includes various gages, indicators, instruments 104, etc., the console 102 typically includes various built in accessories 106 (for instance radios, GPS devices, etc.) and so-called “after-market” accessories 108. In addition, the manufacturer of the vehicle 10 often provides one or more vehicle power outlets 110 somewhere in the vehicle 10 and frequently on the dashboard 100 or console 102. As those skilled in the art appreciate, as the vehicle 10 sinks in water 12 the vehicle 10 fills with water until the water level 112 reaches the power outlet 110 and/or the water 12 fills the vehicle 10. However, the water level 112 may reach and/or stop at other levels in the vehicle 10.

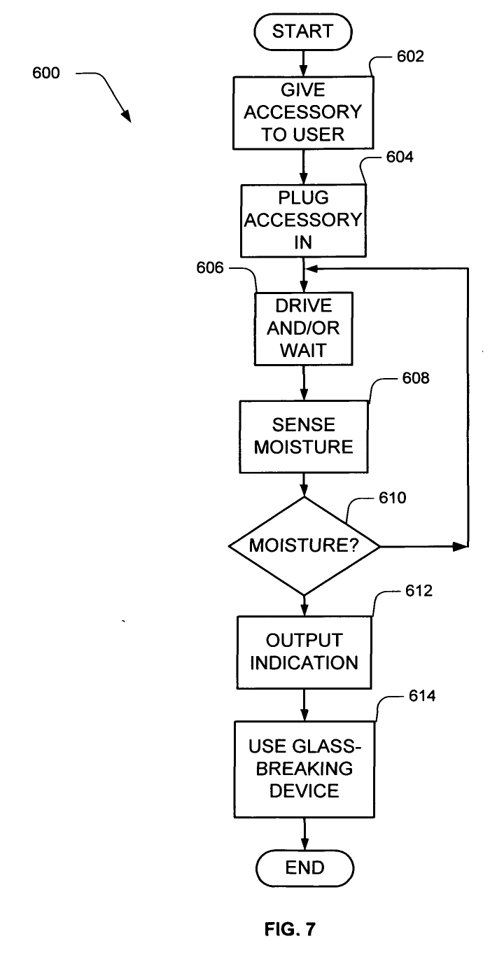

FIG. 2 also illustrates a vehicle accessory 114 for sensing and indicating whether the vehicle 10 is submerged in whole or in part. In some embodiments, the accessory 114 is an after-market accessory. However, the accessory 114 could be built into the vehicle 10. As illustrated by FIG. 2, though, the accessory 114 includes a body 116, a moisture sensor 118, an indicator 120, a power adaptor 122, and a power cord 123 connecting the power adapter 122 to the body 116. In some embodiments, as illustrated by FIG. 2A, the power adaptor 128 serves as the body 116 of an apparatus 106A and includes the moisture sensor 118, indicator 120, and associated circuitry. Moreover, the power adaptor 128 of some embodiments is dimensioned to fit into the vehicle power outlet 110 and has electrical contacts for accepting electrical power there from. These contacts electrically communicate with other components of the accessory 114 to provide electrical power thereto as might be desired. The accessory 106A can include a logo 132 attached to, affixed to, painted on, etched into, or otherwise displayed on (or in association with) the accessory 106A. Some methods of advertising with the logo 132 and, hence, the apparatus 114 are disclosed further herein with reference to FIG. 7.

Nonetheless, in operation, the moisture sensor 118 senses whether moisture is present at its location and generates an output signal indicative of that state. Being responsive to the sensor output signal, the indicator 120 indicates visually, audibly or both whether the moisture sensor 118 senses moisture. In some embodiments, the indicator 120 includes an LED, an ultra-bright LED, a xenon tube (or other visual indicator), a sound generator, or a combination thereof Thus, should the vehicle 10 become submerged, the accessory 114 will generally generate an indication of such a condition at some point at or after that state occurs.

In addition to generating an indication of whether the vehicle 10 is submerged, the accessory 114 also includes a spring-loaded glass-breaking device 124 (or other type of glass-breaking device). It might be worth noting at this juncture that the indicator 120 can be configured to draw attention to itself in various manners. For instance, the indicator 120 can include a visual indicator and/or an audible indicator. Either type of indicator 120 can be configured to be noticeable to even an anxious user 22. For instance an ultra-bright LED type indicator 120 which flashes repeatedly might be noticed even in the environs of a submerged vehicle 10. In addition, or in the alternative, the indicator 120 could generate a sound chosen to be likely to be noticed in the environs of a submerged vehicle 10. Thus, should the vehicle 10 become submerged, the user 22 (or other passenger) of the vehicle might notice the accessory 114 and reach for the same. The user 22 might also remember that the accessory 114 includes the glass-breaking device 124 and use the same to break a window 24 to escape from the vehicle 10. Thus, while it cannot be guaranteed, the presence of the accessory 114 in the vehicle 10 increases the chances that the user 22 will be able to escape from the vehicle 10.

FIG. 3 illustrates a cross sectional view of an apparatus for sensing whether a vehicle is submerged and for enabling a user to escape from the same. The apparatus 200 of FIG. 3 includes an electronic subassembly 202 and a mechanical subassembly 204. In general, the electronic subassembly 202 senses whether the vehicle 10 is submerged and indicates the same while the mechanical subassembly 204 includes a spring-loaded glass-breaking device 124 (or other type of glass-breaking device).

More specifically, the apparatus 200 includes (within the electronic subassembly 202) electrical contacts 206 and 208, a power supply 210, a timer 212, one or more moisture sensors 214, a charger/flash controller 216, and one or more indicators 218. The contacts 206 and 208 can be dimensioned to receive power from a power outlet 110. and can communicate with the various other electric components of the apparatus 200 to supply power thereto. More specifically, the contacts 206 and 208 can communicate with the power supply 210 to supply power thereto for operating the other components of the apparatus 200. In some embodiments, the apparatus 200 includes a circuit for (re)charging a re-chargeable battery contained within the apparatus 200 if it is desired to recharge the re-chargeable battery from the power outlet 110.

With continuing reference to FIG. 3, the timer 212 is illustrated as being in communication with the moisture sensors 214 to receive their output signals. The timer therefore can, responsive to the output signals of the moisture sensors 214, generate a periodic (or other type of) signal to drive the charger/flash controller 216. The charger/flash controller. 216 can receive the signal from the timer 212 and, responsive thereto, develop a charge with which to fire the indicator 218. Moreover, the charger/flash controller can fire the indicator 218 using that charge or another if available at an appropriate time. Thus, the apparatus 200 can indicate whether the vehicle 10 is submerged and, in doing so, draw attention to itself. As illustrated by FIG. 3, the apparatus can also include a sound generator 328 with a pre-recorded message or other audible indication (for instance, a beeper, buzzer, horn, klaxon, etc.) that the vehicle 10 is submerged.

Moreover, and as noted above, the apparatus 200 can include a spring-loaded glass breaking device 124. In the embodiment illustrated by FIG. 3, the spring-loaded glass-breaking device 124 happens to be rigidly coupled to the electronic subassembly 202 although this arrangement need not be the case. For instance, the spring-loaded glass-breaking device 124 (or the mechanical subassembly 204) could be tethered to the electronic subassembly 202. Nevertheless, the spring-loaded glass-breaking device 124 can include a pointed pin 220, a spring 222, a lever 224, a fulcrum 226, and a trigger button 228 operatively arranged as shown by FIG. 3. More specifically, the pin 220 can be shaped to provide a sharp point which if impacted against a vehicle window 24 (with a force known to break the same) can break the window 24 thereby enabling the user 22 to escape from the vehicle 10.

To allow a user 22 to use the spring-loaded glass-breaking device 124, the spring 222 can be operatively connected to the pin 220 and anchored to a portion of the apparatus 200. Moreover, the spring 222 can be held in compression by the lever 224 during periods of inactivity. The lever 224 can also pivot about the fulcrum 226 which is coupled to a portion of the apparatus 200. Furthermore, the button 228 can abut the end of the lever 224 opposite the end of the lever which holds the spring 222 in place. If desired, the button 228 can be positioned such that if a user 22 actuates it, the button 228 rotates the lever 224 about the fulcrum 226 thereby releasing the spring 222. After being released, the spring 222 can drive the pin 220 forward with sufficient force to break a vehicle window 24. Accordingly, the spring 222 can be a compression spring which develops enough force (as applied by the pin 220) to break a vehicle window.

Moreover, in some embodiments, the. apparatus 200 includes a hollow body 230 on which the various other components of the apparatus 200 can be mounted. Thus, all or a portion of the electronic subassembly 202 and/or the mechanical subassembly 204 can be operatively mounted on the body 230. Indeed, in some embodiments, most of the components of the electronic subassembly 202 and the mechanical subassembly 204 are mounted on, and internally within, the body 230 of the apparatus 200. Additionally, the body 230 can be filled with an epoxy 232 Or other material to insulate the electrical components of the apparatus 200 and to provide some degree of water resistance thereto. Thus, should the apparatus 200 itself become submerged it can continue to operate for at least some time thereafter.

Some components, though, can protrude from the body 230 without departing from the scope of the disclosure. For instance, the contacts 206 and 208 may protrude through the body 230 to accept power from the power outlet 110 and to communicate the power to other electric components. Moreover, the moisture sensors 214 could be positioned partly or entirely outside of the body 230. The moisture sensors 214 could be at or near points on the apparatus 200 which will likely be in relatively low positions should the vehicle 10 become submerged. In other embodiments, the moisture sensors 214 can be positioned elsewhere. For instance, the moisture sensors could be positioned at points on the apparatus 200 which will be just outside of the vehicle power outlet 110 when the apparatus 200 is inserted therein. More specifically, a portion of each of the moisture sensors 214 which is configured to interact with water (thereby enabling the moisture sensor 214 to sense its presence) may be exposed to the environment outside of the body 230.

Furthermore, the apparatus 200 can be assembled in a generally “T” shaped or other configuration. In such embodiments, a power adaptor portion 234 of the apparatus 200. which forms the stem of the “T” can be dimensioned to fit within the vehicle power outlet 110 while the indicator 218 and the spring-loaded glass breaking device 124 can be positioned on the upper, cross-bar portion 236 of the apparatus 200. For instance, the indicator 218 could be positioned to be seen by the user 22 of the vehicle 10 while the user 22 is driving the vehicle 10. It might also be the case that the spring-loaded glass-breaking device 124 is positioned at an end of the upper, cross-bar portion 236 as illustrated by FIG. 3. However, it is to be noted that While the cross-bar portion 236 has been described as being an “upper” portion, no limitation on its placement or orientation is hereby implied.

In some embodiments, the apparatus 200 can be configured such that the cross-bar portion 236 is symmetrical about the power adaptor portion 234. However, the cross-bar portion 236 need not be symmetrical about the power adaptor portion 234. Thus, one side of the cross-bar portion 236 can include the spring-loaded glass-breaking device 124 while the other side of the cross-bar portion 236 can include some or all of the electronic components of the apparatus 200. Of course, even the side of the cross-bar portion 236 including the spring-loaded glass-breaking device 124 could include some or all of the electronic components of the apparatus 200. Moreover, the spring-loaded glass-breaking device 124 could be located elsewhere on the apparatus 200 without deputing from the scope of the disclosure.

Moreover, the spring-loaded glass-breaking device 124 can be housed in a portion of the apparatus 200 that is separate from another portion of the apparatus housing the electronic components thereof. As a result, even though the pin 220 and the button 228 penetrate the portion of the body 230 associated therewith, should any leakage around these components intrude into the body 230, the electronic components of the apparatus 200 can be isolated from such leakage. Thus, the apparatus 200 can continue to function adequately even if it becomes submerged to some depth.

Nonetheless, should the moisture sensor 214 sense the presence of moisture, the indicator 218 can indicate that such moisture has been sensed. The user 22 of the vehicle 10 might therefore notice the indicator 218 in such circumstances and might also remember that the apparatus 200 includes the spring-loaded glass-breaking device 124. This realization might lead the user to realize that the apparatus 200 can be used to escape from the vehicle 10. As a result, the user 22 might grasp the apparatus 200 by the cross-bar portion 236 and remove it from the vehicle power outlet 110. The user 22 might then position the apparatus 200 such that the spring-loaded glass-breaking device 124 is pressed against a window 24 of the vehicle 10 in preparation for breaking the window 24. Moreover, the user 22 might actuate the button 228 thereby releasing the pin 220 to impact the window 24. As a result, the window 24 can be broken thereby enabling the user 22 to escape from the vehicle 10.

With continuing reference to FIG. 3, the “T” shape of the apparatus 200 can facilitate a user 22 grasping the apparatus 200 by the cross-bar portion 236 and removing the apparatus from the power outlet 110. Furthermore, in some embodiments, the epoxy 232 can provide mechanical strength to the apparatus 200 to resist compressive forces exerted on the cross-bar portion 236 by an anxious user 22. In addition, or in the alternative, positioning the spring-loaded glass-breaking device 124 on an end of the cross-bar portion 236 can facilitate a driver (i.e. a user 22) reaching across the passenger seat of the vehicle 10 and pressing the spring-loaded glass-breaking device 124 against the passenger-side window by extending his/her arm. In addition, or in the alternative, positioning the spring-loaded glass-breaking device 124 on an end of the cross-bar portion 236 can facilitate a driver reaching across his/her own body and pressing the spring-loaded glass-breaking device 124 against the driver-side window.

FIG. 4 illustrates a block diagram of an apparatus for sensing whether a vehicle is submerged. As illustrated by FIG. 4, the apparatus 300 includes a power supply 310, a timer 312, a moisture sensor 314, a charger/flash controller 316, an indicator 318, and an inverter 320. The power supply 310 provides power to the timer 312 from the contacts 206 and 208. In the meantime, moisture sensor 314 (via the inverter 320) sends an output signal 322 to the timer 312 to control the same. In some embodiments, the inverter 320 is omitted. However, in other embodiments, the inverter 320 is a high impedance device which works with a normally-closed moisture sensor 314 while minimizing the power drawn from the power outlet 110 (and hence the battery of the vehicle 10). Nonetheless, the timer 312, responsive to the output signal 322 of the moisture sensor 314 (as modified by the inverter 320 if desired), delivers power 324 to the charger/flash controller 316. In addition, the timer 312 can deliver a flash signal 326 to the charger/flash controller 316.

Thus, as the timer 312 is delivering power 324 to the charger/flash controller 316, the charger/flash controller 316 can build a charge with which to fire the indicator 318. When the timer 312 delivers a flash signal 326 to the charger/flash controller 316, the charger/flash controller 316 can fire the indicator 318 using the developed charge. It might be useful to note at this juncture that the timer 312 and the charger/flash controller can be configured to operate in such a manner that the timer 312 delivers the flash signal 326 to the charger/flash controller 316 at the end of, or after, the time which the charger/flash controller 316 uses to build the charge for the indicator 318. Of course, the indicator 318 and the charger/flash controller 316 can be configured such that the charge developed by the charger/flash controller 316 is sufficient to fire the indicator 318.

Thus, in operation, the apparatus 300 can work generally as follows. During typical driving environments (not submerged), the moisture sensor 314 senses that no moisture is present in its immediate. surroundings. As a result, the timer 312 delivers no, or little, power 324 to the charger/flash controller 316. Moreover, during such times, the timer delivers no flash signal 326 to the charger/flash controller 316. Responsive to these conditions, the charger/flash controller 316 can either build a charge (if it is supplied with power from some source) or it can be configured to not do so.

However, should the vehicle 10 in which the apparatus is located becomes submerged at some point water will likely reach the moisture sensor 314. Accordingly, the moisture sensor 314 senses the water and sends a corresponding output signal 322 to the timer 312. Upon receiving such an output signal 322 from the moisture sensor 314, the timer 312 begins sending power 324 to the charger/flash controller 316. With that power 324, the charger/flash controller 316 begins building a charge with which to fire the indicator 318. At a selected time, the timer 312 can send a flash signal 326 to the charger/flash controller 316. Upon receiving the flash signal 326, the charger/flash controller 316 can fire the indicator 318. Then, since the timer 312 continues to send power 324 to the charger/flash controller 316, the charger/flash controller 316 can begin building another charge with which to again fire the indicator 318. At an appropriate time at or after moisture is first sensed, periodically, or otherwise, the timer 312 can send power and flash signals 324 and 326 to the charger/flash controller 316 to fire the indicator 318.

In addition, or in the alternative to a visual indicator, the apparatus 300 can include a sound generator 328. The sound generator could be any type of sound generator such as a buzzer, beeper, horn, klaxon, etc. For instance, the sound generator 328 could include an integrated circuit (or other device) which, in conjunction with a speaker, or other transducer, could generate an audible signal conveying such information as may be desired. In some embodiments, the sound generator 328 generates a verbal instruction such as “Escape Tool Here”. Of course, any other selected message could be generated by the sound generator 328.

As a result, the user 22 might notice the first firing of the indicator 318 despite other events that might be occurring in the vehicle 10. Even if the user 22 fails to notice the first such indication from the indicator, the user 22 (or other passenger) might notice subsequent indications from the indicator 318. At some point, some user 22 in the car might remove the apparatus 300 from the power outlet 110 and use the spring-loaded glass-breaking device 124 to escape from the vehicle 10.

Apparatus 300 could employ (with suitable modifications) a lamp flasher circuit for the timer 312. Moreover, apparatus 300 could employ (with suitable modifications) a xenon tube charging/flash circuit as the charger/flash controller 316. In such apparatus 300, the indicator 318 could be a suitable xenon tube. For instance, in one embodiment, a lamp flasher from a vehicle turn-light circuit, a lamp flash circuit from a disposable camera, and a xenon tube from a disposable camera serve respectively as the timer 312, the charger/flash controller 316, and the indicator 318.

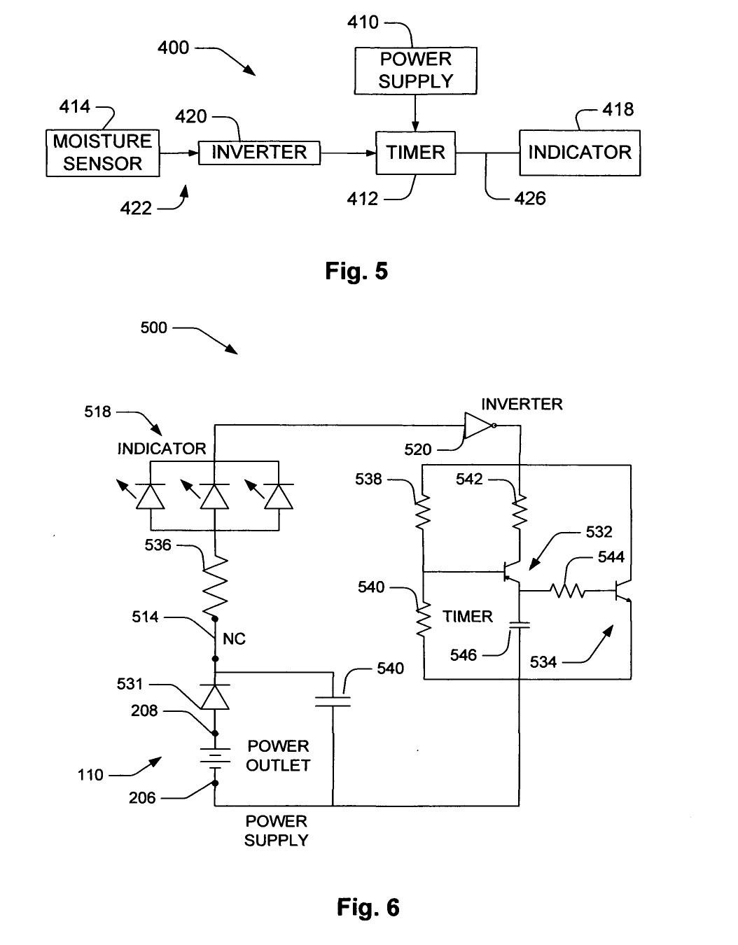

FIG. 5 illustrates a block diagram of another apparatus for sensing whether a vehicle is submerged. The apparatus 400 includes a power supply 410, a timer 412, a moisture sensor 414, and an indicator 418. In such embodiments, the apparatus 400 omits a charger/flash controller and instead uses an output signal 426 of the timer 412 to drive the indicator 418 at a selected times. Thus, when the moisture sensor 414 senses moisture, the output signal 422 causes the timer 412 to supply power to the indicator 418 as desired thereby causing the indicator to produce an indication that the vehicle 10 is submerged.

FIG. 6 illustrates a schematic diagram of a circuit for sensing whether a vehicle is submerged. The circuit 500 includes a power supply 510, a timer 512, a moisture sensor 514, and an indicator 518. In addition, the circuit 500 includes a storage capacitor 530, a pnp (positive-negative-positive) transistor 532, an npn (negative-positive-negative) transistor 534, a power conditioning resistor 536, biasing resistors 538 and 540, a collector resistor 542, an emitter resistor 544, and a timing capacitor 546. These components work together to cause indicator 518 to indicate that the moisture sensor 514 senses the presence of moisture (and that, therefore, the vehicle 10 in which it resides might be submerged).

Generally, the circuit 500 includes a modified “flash lamp” circuit that can be used to flash a lamp (or other indicator) at a selected frequency. However, other uses such as those describe herein and obvious modifications thereto are within the scope of the disclosure.

With continuing reference to FIG. 6, the power supply 510 receives power from the power outlet 110 via contacts 206 and 208. With this power, the power supply 510 powers the remainder of the circuit 500. In addition, power received from the power outlet 110 flows to the storage capacitor 530 which is selected to provide power to the remainder of the circuit 500 should power from the power outlet 110 fail or otherwise become unavailable. Moreover, diode 531 prevents the storage capacitor 530 from discharging across the power outlet 110 should the voltage across the storage capacitor 530 exceed that across the power outlet 110 (or across the contacts 206 and 208).

With regard to the moisture sensor 514, in the embodiment illustrated by FIG. 6, this component can be a sensor configured in a normally closed state. Thus, while the moisture sensor 514 senses the absence of moisture it remains in the closed state. However, should the moisture sensor 514 sense moisture, it opens indicating that moisture is present. This configuration of the moisture sensor 514 enables it to control the operation of the remainder of the circuit 500. In a normally closed configuration, the moisture sensor 514 also enables the circuit 500 to indicate an “open wire” condition in some of the circuit 500. Thus, should One Of the wires, components, etc. in this portion of the circuit 500 transition to an “open” state, the circuit 500 will cause the indicator 518 to indicate a failure thereof via the indicator 518.

The power conditioning resistor 536 can be chosen (in conjunction with choosing other components of the circuit 500) to set the voltage across the indicator 518 to a range suitable therefore. Thus, the power conditioning resistor 536 and the indicator 518 can be selected together if desired.

With regard to the indicator 518 illustrated by FIG. 6, the indicator 518 can be any type of indicator desired. For instance, the indicator 518 can be a visual indicator, an audible indicator, etc. In some embodiments, the indicator 518 is an ultra-bright LED. However, the indicator 518 can include an LED, multiple LEDs, multiple ultra-bright LEDs, xenon tube(s), other flash devices, sound generators, etc. as is desired. For instance, in some embodiments, the indicator 518 includes multiple LEDs configured to spell a message such as “Glass Breaker Here”.

With continuing reference to FIG. 6, the inverter 520 inverts the signal output by the moisture sensor 514 (downstream of the indicator 518). Thus, the inverter enables a normally closed moisture sensor 514 to control the particular timer 512 illustrated by FIG. 6. However, the inverter 520 could be omitted if a normally open moisture sensor 514 or other type of timer 512 is used in circuit 500.

With regard to the biasing resistors 538 and 540, these resistors establish a threshold voltage which, when developed across capacitor 546, cause the timer 512 to conduct electricity thereby turning the indicator 518 on. Resistors 542 and 544 assist biasing resistors 538 and 540 in establishing biasing voltages on the transistors 532 and 534. Capacitor 546 and resistors 536 and 542 (along with other sources of resistance in the circuit 500) gives rise to a time constant for the circuit which determines how long it takes to turn the indicator 518 on and how long indicator 518 remains on during each period of the circuit 500. Thus, these components can be selected to cause the indicator 518 to flash at a selected frequencies.

FIG. 7 illustrates a flowchart of a method for advertising and for sensing whether a vehicle is submerged. The method 600 can begin with giving one or more of the accessories 106A (see FIG. 2A) to a user 22. More specifically, a geographic area can be selected in which flash floods (or other sources of water) trap users 22 in vehicles 10. at or above some pre-determined rate, likelihood, etc. The accessories 106A can include surfaces on which an advertisement (i.e. a company logo 132) is placed. The advertisement can be for an insurance company, vehicle towing service, vehicle repair service, etc. and the entity which is thereby advertised can be the source of the accessories 106A. In some instances, such as when the entity is a car rental agency, or a car rental agency is involved in the distribution of the accessories 106A, the accessories 106A can be left in the vehicle 10 for the next renter to use, take, etc. Indeed, in some cases, the accessories 106A can be left plugged into the power outlet 110. Moreover, should some event (such as a flash flood in some geographic) occur which traps some users 22 in one or more vehicles 10, the accessories 106A can be given away in and/or near the selected geographic area. Moreover, such giveaways can occur during or shortly after media coverage of the event and resulting media coverage. Nonetheless, the user 22 receives an accessory 106A. Of course, a supplier of the accessories 106A can sell the accessory 106A to the user 22 (thereby giving it to the user 22 as part of the exchange). See reference 602.

If the accessory 106A is not plugged in to a power outlet 110, then at some point it may be plugged into one. See reference 604. During times when power is available from the power outlet 110, the accessory 106A charges storage capacitor 530. Also, since the moisture sensor 514 of the current embodiment is normally closed, the voltage of the components on the high side of the power outlet 110 (up to the inverter 520) might rise to approximately the voltage of the power outlet 110. Indeed, when the accessory 106A is plugged in, the initial flow of power can momentarily drive the indicator 518 to its “on” state to alert the user 22 to its presence in the vehicle 10. However, the accessory 106A need not be configured to do so. Otherwise, the indicator 518 typically remains in its off state since little or no current is flowing through it. In addition, if a rechargeable battery and battery recharger (not shown) are included in the accessory 106A, the battery recharger can begin recharging the battery. See reference 604.

During many typical driving situations, no moisture will be present at the moisture sensor 514. As a result, typically, some amount of time will pass before the moisture sensor 514 senses any moisture. During this time the user 22 may be driving the vehicle 10 constantly, intermittently, or otherwise. See reference 606.

At some point, though, the moisture sensor 514 might sense the presence of moisture. See reference 608. Since the moisture sensor 514 can be a normally closed sensor 514 it can open upon sensing moisture. Of course, the moisture sensor 514 of some embodiments is a normally open sensor. In which case or as otherwise desired, the inverter 520 could be dispensed with. Nonetheless, upon opening, the moisture sensor 514 of the current embodiment causes the voltage at the input to the inverter 520 to drop. In some embodiments, a pull down resistor internal to the inverter 520 assists in pulling the inverter 520 input voltage down. It is also possible that an external pull down resistor could be furnished to do so instead, or in conjunction with, the internal pull down resistor of the inverter 520. Nonetheless, the resulting drop in voltage at the inverter 520 input causes the inverter 520 output to go high. Note that the inverter 520 can communicate with the power supply 510 to receive power if desired.

Thus, as indicated at reference 610 it is determined that moisture is being sensed. If not, method 600 includes waiting for moisture to be sensed as indicated by the loop which includes references 606, 608, and 610. However, method 600 includes certain actions which can be taken if moisture is sensed. These actions include indicating that moisture is being sensed and/or that the vehicle 10 is submerged. See reference 612. Such indications can be output via an audio or a visual indicator 118 as may be desired.

Depending on the user's situational awareness, the user 22 can notice the indicator 118 and therefore be prompted to remember that the accessory 106A includes a spring-loaded glass-breaking device 124. If so, the user 22 can remove the accessory 106A from the power outlet 110 and use the spring-loaded glass-breaking device 124 to break a window 24 and escape from the vehicle 10. Of course, other types of glass-breaking devices (for instance a CO2-cartridge driven glass-breaking device could be employed in the embodiments of FIGS. 1-7). See reference 614.

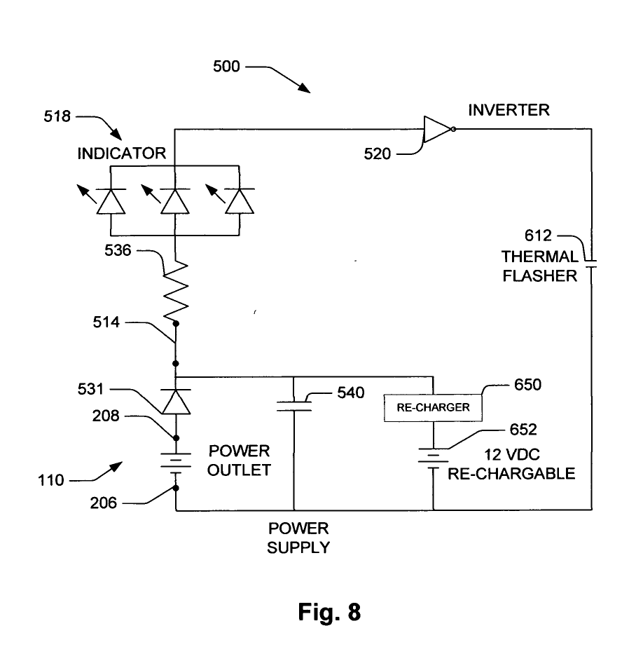

FIG. 8 illustrates a schematic diagram of a circuit for sensing whether a vehicle is submerged. More specifically, FIG. 8 illustrates a circuit 700 which shares some similarity with circuit 500 of FIG. 6. However, circuit 700 includes a thermal flasher 712 serving as a timer. In one embodiment, the thermal flasher is a model number 577, Extra Loud, thermal flasher available from Cooper Bussman of St. Louis, Mo. The thermal flasher 712 operates by warming as current flows through it. At some temperature, the thermal flasher 712 opens thereby opening the circuit 700 and stopping current flow there through. When the thermal flasher 712 cools below the aforementioned temperature, it closes thereby allowing current to flow through the circuit 700.

Thus, in operation, the circuit 700 operates as follows. When the moisture sensor 512 senses moisture, the output of the inverter 520 goes high thereby powering the thermal flasher 712. At some point, the thermal clasher 712 reaches its operational temperature and allows current to flow through itself and the indicator 518. Thus, the indicator 518 turns on. When the thermal flasher 712 cools below its operational temperature and opens the indicator 518 turns off. This process repeats until the moisture sensor 514 closes indicating that moisture is no longer present. Accordingly, by selecting the thermal flasher 712, the period can be selected at which the circuit 700 flashes the indicator 518. Note that, if the circuit 700 is incorporated in the accessory 200 filled with epoxy 232 (see FIG. 3), the epoxy 232 can thermally insulate the thermal flasher 712 from the water 12 which may be at a relatively cool temperature depending on circumstances.

In addition, FIG. 8 illustrates that the circuit 700 can include a battery recharger 750 and a rechargeable battery 752. These components communicate with the power supply 510 to receive power there from and store that power in the rechargeable battery 652 for subsequent use. Thus, the rechargeable battery 652 provides a source of power with which circuit 700 can operate should power not be available from the power outlet 110.

### CONCLUSION

Although the subject matter has been described in language specific to certain embodiments, it is understood that the subject matter defined in the appended claims is not necessarily limited to the specific embodiments disclosed herein. Rather, the specific embodiments disclosed herein are illustrative embodiments for implementing the claims.

What is claimed is:

1. A vehicle accessory for sensing whether a vehicle is partially or completely submerged, for alerting a user of the vehicle to the same, and for enabling the user to escape by breaking a window with the accessory, the accessory comprising:
a circuit including:
a moisture sensor configured to generate an output signal responsive to whether the moisture sensor senses moisture,
an indicator in communication with the moisture sensor and being configured to output an indication of whether the moisture sensor senses moisture responsive to the sensor output signal,
a power adapter in communication with the circuit to supply power to the circuit and being dimensioned to fit in a vehicle power outlet;
a spring-loaded glass-breaking device; and
a body on which the moisture sensor, the indicator, and the spring-loaded glass-breaking device are mounted.

2. The accessory of claim 1 wherein the indicator includes a sound generator of the circuit, the sound generator being in communication with the moisture sensor and being configured to generate an audible signal responsive to the sensor output signal.

3. The accessory of claim 1 wherein the power adapter is mounted on the body.

4. The accessory of claim 1 wherein the power adapter is the body.

5. The accessory of claim 1 wherein the circuit includes a re-chargeable battery and a battery recharging circuit in communication with the battery and the power adapter and being configured to recharge the battery.

6. The accessory of claim 1 wherein the indicator includes an LED.

7. The accessory of claim 1 wherein the body includes a surface for accepting an advertising logo.

8. The accessory of claim 1 wherein the circuit further includes a timer in communication with the moisture sensor and being responsive to the sensor output signal to cause the indicator to output the indication periodically.

9. An apparatus comprising:
a circuit including:
a moisture sensor configured to generate an output signal responsive to whether the moisture sensor senses moisture,
an indicator in communication with the moisture sensor and being configured to output an indication of whether the moisture sensor senses moisture responsive to the sensor output signal,
a power adapter in communication with the circuit to supply power to the circuit and being dimensioned to fit in a vehicle power outlet; and
a body on which the moisture sensor and the indicator are mounted.

10. The apparatus of claim 9 further comprising a spring-loaded glass-breaking device mounted on the body.

11. The apparatus of claim 9 wherein the indicator includes a sound generator of the circuit, the sound generator being in communication with the moisture sensor and being configured to generate an audible signal responsive to the sensor output signal.

12. The apparatus of claim 9 wherein the power adapter is mounted on the body.

13. The apparatus of claim 9 wherein the power adapter is the body.

14. The apparatus of claim 9 wherein the circuit includes a re-chargeable battery and a battery recharging circuit in communication with the battery and the power adapter and being configured to recharge the battery.

15. The apparatus of claim 9 wherein the indicator includes an LED.

16. The apparatus of claim 9 wherein the body includes a surface for accepting an advertising logo.

17. The apparatus of claim 9 wherein the circuit further includes a timer in communication with the moisture sensor and being responsive to the sensor output signal to cause the indicator to output the indication periodically.

18. A method of advertising comprising:
placing an advertisement on a vehicle accessory; and
giving the accessory to a driver, the accessory including:
a circuit including:
a moisture sensor configured to generate an output signal responsive to whether the moisture sensor senses moisture,
an indicator in communication with the moisture sensor and being configured to output an indication of whether the moisture sensor senses moisture responsive to the sensor output signal,
a power adapter in communication with the circuit to supply power to the circuit and being dimensioned to fit in a vehicle power outlet; and
a body on which the moisture sensor and the indicator are mounted.

19. The method of claim 18 further wherein the accessory further includes a spring-loaded glass-breaking device mounted on the body.

20. The method of claim 18 wherein the indicator includes an LED.
